(19) United States
(12) Patent Application Publication
(10) Pub. No.: US 2020/0341307 A1
(43) Pub. Date: Oct. 29, 2020

(54) AMLCD WITH DUAL REDUNDANT PIXEL ARRAYS AND LAYOUT FOR SCALABLE VIEWING AREA

(71) Applicant: CEVIANS LLC, Costa Mesa, CA (US)

(72) Inventors: Eric Lemay, San Juan Capistrano, CA (US); Gunwoo Kim, Irvine, CA (US); Jean-Luc Bouchard, Vaudreuil (CA); Benjamin George Phipps, Long Beach, CA (US)

(21) Appl. No.: 16/846,050

(22) Filed: Apr. 10, 2020

Related U.S. Application Data
(60) Provisional application No. 62/833,543, filed on Apr. 12, 2019.

(51) Int. Cl. G02F 1/1368; G02F 1/1362

(52) U.S. Cl. CPC G02F 1/1368; G02F 2001/136254; G02F 1/136259; G02F 1/136286

(57) ABSTRACT

An AMLCD sub-pixel electrical connection array integrating dual redundancy of its entire active area is provided in some implementations. Some implementations include integration of independent sets of ICs that drive the primary and the secondary TFTs for each pixel with a shared liquid crystal fluid. The AMLCD structure can include independent electrical conductors that are patterned similarly and aligned to reduce offset to prevent a significant optical loss due to the reduced aperture ratio caused by the redundant electrical circuit. Such assembly can also provide an AMLCD that is capable of resizing possibly without modification of the display panel design.

### INCORPORATION BY REFERENCE TO ANY PRIORITY APPLICATIONS

This application claims the benefit of priority under 35 U.S.C. § 119(e) to U.S. Provisional Application No. 62/833,543 filed Apr. 12, 2019, entitled “AMLCD WITH DUAL REDUNDANT PIXEL ARRAYS AND LAYOUT FOR SCALABLE VIEWING AREA,” which is hereby incorporated by reference herein in its entirety.

### BACKGROUND

### Field

This disclosure relates to the array of thin film transistors (TFTs) in a single active matrix liquid crystal display (AMLCD) that has inherent redundancy as a result of using a primary and secondary TFT that share the liquid crystal (LC) fluid in the middle. Such AMLCD may have the flexibility to be finished at different active area sizes without the need for new masks.

### Description of the Related Art

Active matrix liquid crystal displays (AMLCDs) have been integrated in high reliability environments such as aircraft cockpits due to their high definition digital content and achievement of mass productivity. In some instances, the display panel is being integrated in instruments that are used in flight critical applications. Furthermore, there has been a trend to combine information on one large area display (LAD) instead of using multiple smaller displays. In these critical applications such as cockpit instrumentations, there are a number of safety requirements that are met by the redundancy of multiple independent displays. In essence, the failure of a single display is mitigated by the use of other displays to which the information is available.

Some AMLCDs have been developed to provide redundancy. While these AMLCDs may provide adequate redundancy, their designs have significant limitations. In some instances, a failure would lead to the loss of half the display screen, forcing the user to operate with a limited display. Other systems have been developed by integrating two distinct AMLCDs side-by-side. While this approach may insure independency of the system elements, its use remains limited to applications that do not display imagery in its center as there always is a mullion which distracts users.

One single redundant segmented AMLCD glass strategy involves electrical termination of pixel rows with integrated circuits (ICs) on both sides of the rows. The same is true for the columns. In a typical embodiment of this strategy, there are ICs chips whether on flex or on glass on all four sides of the array.

The single redundant AMLCD may also include multiple thin film transistors (TFTs) and the source/gate lines, which can cause a reduced aperture ratio. A conventional optical transmission for the AMLCD is about 5% and accordingly, such a reduced aperture ratio can lead to a significant optical loss.

A typical redundant AMLCD may require a photolithography pixel mask set that is specific to a display's active area and that requires the ICs on all sides for its function. Various implementations described herein provide an improved redundancy solution. Various designs described herein, for example, can provide redundancy of its entire active area without the loss of one half of the screen and at the same time locate ICs on two sides (e.g., only two sides as opposed to four sides) of the array so that a single pixel mask set can be used to produce arrays that will be subsequently finished to various different active area sizes.

### SUMMARY

Various implementations in the present disclosure are directed to a single AMLCD including an arrangement of its electronic arrays, primary and secondary thin film transistors (TFTs) and integrated circuits (ICs) such that it provides a dual redundant pixel arrangement of its active area.

The pixel can comprise two sets of TFTs on a primary and secondary TFT substrate (e.g., glass), respectively. Primary and the secondary source/gate lines can be patterned on one or both sides of the TFT substrate with relatively low (e.g., minimized) offsets to secure relatively high (e.g., maximum) aperture ratio per pixel. A shared LC fluid can be placed in between the primary and secondary TFT substrates and can be driven by both TFTs (e.g., alternately one or the other TFTs, for example, one of the TFT's can switch the liquid crystal if the other TFT can no longer drive the LC due to some failure).

The color filters and the black matrix for the sub-pixels can be patterned on a top or front side of the secondary TFT substrate (e.g., glass).

In some implementations, the present disclosure is directed to an AMLCD TFT array that terminates all of its ICs on two sides of the array.

The implementations disclosed herein may include any one or more of several possible advantages over other approaches: provides redundancy of entire display active area or allows the manufacture of different redundant display sizes using a single set of pixel masks.

Accordingly, various implementations describe herein may include an AMLCD sub-pixel electrical connection array integrating dual redundancy of an active area. Some implementations include integration of independent sets of ICs that drive primary and secondary TFTs for each pixel with a shared liquid crystal fluid. The AMLCD structure can include independent electrical conductors that are patterned similarly and aligned to reduce offset to prevent a significant optical loss due to the reduced aperture ratio caused by the redundant electrical circuit. Such assembly can also provide an AMLCD that is capable of resizing possibly without modification of the display panel design.

### EXAMPLES

A variety of example displays and methods are provided below. Any of the following examples can be combined.

1. An active matrix liquid crystal display that is electrically redundant comprising:
primary and secondary thin film transistor (TFT) substrates sharing the same nematic fluid, the primary and secondary TFT substrates vertically aligned on or above one another; and
redundant sets of source and gate driver ICs that are attached to the primary and secondary TFT substrates.

2. The active matrix liquid crystal display that is electrically redundant of example 1, wherein a color picture element contains NIR absorbers.

3. The active matrix liquid crystal display that is electrically redundant of example 1, wherein a user or pilot can switch between a primary and secondary display function when a failure is detected.

4. The active matrix liquid crystal display that is electrically redundant of example 1, wherein the secondary TFT substrate is configured to act as an electrical ground plane for the primary TFT substrate and the primary TFT substrate is configured to act as a ground plane for the secondary TFT substrate.

5. The active matrix liquid crystal display that is electrically redundant of example 1, further comprising:
a redundant control system with a first power supply in electrical communication with a first display interface board (DIB); and
a second power supply in electrical communication with a second DIB.

6. The active matrix liquid crystal display that is electrically redundant of example 1, further comprising a redundant control system with a graphics processor in electrical communication with a first and second display interface board (DIB).

7. The active matrix liquid crystal display that is electrically redundant of example 1, further comprising a redundant control system with a reversionary control in electrical communication with a graphics processor, wherein the reversionary control is configured to allow a user to switch between a first and second display interface board (DIB).

8. The active matrix liquid crystal display that is electrically redundant of example 1, further comprising a redundant control system with a graphics processor adapted to detect a failure in a first source driver, first gate driver, or first display interface board (DIB) and wherein the first DIB is adapted to detect a failure in the first source driver or first gate driver.

9. An active matrix liquid crystal display that is electrically redundant and can be resized comprising:
primary and secondary thin film transistor (TFT) substrates sharing the same nematic fluid, the primary and secondary TFT substrates vertically aligned on or above one another; and
redundant sets of source and gate driver ICs that are attached to the primary and secondary TFT substrates.

10. The active matrix liquid crystal display that is electrically redundant of example 9, wherein a color picture element contains NIR absorbers.

11. The active matrix liquid crystal display that is electrically redundant of example 9, wherein an active area of the resized LCD is determined by a location of a seal placed on an active TFT pixel element prior to adding the nematic fluid.

12. An active matrix liquid crystal display that can be resized, wherein an active area of the resized LCD is determined by a location of a seal placed on an active TFT pixel element prior to adding nematic fluid.

13. A liquid crystal display (LCD) with electrical redundancy, the LCD comprising:
a plurality of pixels, individual pixels comprising a plurality of sub-pixels;
a first thin film transistor (TFT) substrate comprising a first substrate supporting a first array of TFTs;
a second TFT substrate comprising a second substrate supporting a second array of TFTs, the second TFT substrate disposed above the first TFT substrate;
liquid crystal (LC) disposed between the first and second TFT substrates,
wherein at least one TFT of the first array and at least one TFT of the second array are configured to alternatively activate a sub-pixel of the plurality of sub-pixels to provide electrical redundancy.

14. The LCD of example 13, further comprising:
a first set of integrated circuits (ICs) electrically connected to the first TFT substrate and configured to drive TFTs in the first array of TFTs; and
a second set of ICs electrically connected to the second TFT substrate and configured to drive TFTs in the second array of TFTs.

15. The LCD of example 14, wherein the first set of ICs comprises a first set of source and gate driver ICs, and the second set of ICs comprises a second set of source and gate driver ICs.

16. The LCD of any of examples 14-15, wherein the first set of ICs comprises a first set of row and column drivers, and the second set of ICs comprises a second set of row and column drivers.

17. The LCD of any of examples 13-16,
wherein the first and second TFT substrates each comprises:
   a first side,
   a second side adjacent the first side,
   a third side adjacent the second side and opposite the first side, and
   a fourth side adjacent the first and third sides and opposite the second side,
wherein the first set of ICs is disposed on the first and second sides of the first TFT substrate and not said third and fourth sides of the first TFT substrate, and
wherein the second set of ICs is disposed on the third and fourth sides of the second TFT substrate and not said first and second sides of the second TFT substrate.

18. The LCD of example 17, wherein no TFT on said first substrate is electrically connected to an IC on said third and fourth sides of the first TFT substrate.

19. The LCD of any of examples 17-18, wherein no TFT on said second substrate is electrically connected to an IC on said first and second sides of the second TFT substrate.

20. The LCD of any of examples 17-19, wherein no TFT on said first substrate is configured to be driven by an IC on said third and fourth sides of the first TFT substrate.

21. The LCD of any of examples 17-20, wherein no TFT on said second substrate is configured to be driven by an IC on said first and second sides of the second TFT substrate.

22. The LCD of any of examples 14-21, further comprising a control configured to switch between the first and second sets of ICs.

23. The LCD of any of examples 13-22, wherein the first and second TFT substrates each comprises a plurality of row and column electrodes.

24. The LCD of example 23, wherein the row and column electrodes of the first TFT substrate and the row and column electrodes of the second TFT substrate are substantially aligned, substantially overlapping, and substantially without offset with respect to each other.

25. The LCD of example 23, wherein the row and column electrodes of the first TFT substrate and the row and column electrodes of the second TFT substrate are aligned and overlapping such that the average offset with respect to each other is less than 10%.

26. The LCD of example 23, wherein the row and column electrodes of the first TFT substrate and the row and column electrodes of the second TFT substrate are aligned and overlapping such that the average offset with respect to each other is less than 20%.

27. The LCD of any of examples 13-26, wherein the first and second arrays of TFTs each comprise two-dimensional (2D) arrays.

28. The LCD of any of examples 13-27, wherein the majority of TFTs of the first array and the majority of TFTs of the second array are configured to alternatively activate a majority of the sub-pixels of the plurality of sub-pixels to provide electrical redundancy.

29. The LCD of any of examples 13-27, wherein the TFTs of the first array and the TFTs of the second array are each configured to activate all of the sub-pixels to provide electrical redundancy.

30. The LCD of any of examples 13-29, wherein the first array and the second array each include at least 1000 TFTs and at most 5000 TFTs.

31. The LCD of any of examples 13-29, wherein the first array and the second array each include at least 3000 TFTs and at most 5000 TFTs.

32. The LCD of any of examples 13-29, wherein the first array and the second array each include at least 5000 TFTs.

33. The LCD of any of examples 13-32, wherein the plurality of pixels comprise at least 1000 TFTs and at most 5000 TFTs.

34. The LCD of any of examples 13-32, wherein the plurality of pixels comprise at least 3000 TFTs and at most 5000 TFTs.

35. The LCD of any of examples 13-32, wherein the plurality of pixels comprise at least 5000 TFTs.

36. The LCD of any of examples 13-35, wherein 1000 TFTs of the first array and 1000 TFTs of the second array are configured to alternatively activate 1000 sub-pixels of the plurality of sub-pixels to provide electrical redundancy.

37. The LCD of any of examples 13-35, wherein 3000 TFTs of the first array and 3000 TFTs of the second array are configured to alternatively activate 3000 sub-pixels of the plurality of sub-pixels to provide electrical redundancy.

38. The LCD of any of examples 13-35, wherein 5000 TFTs of the first array and 5000 TFTs of the second array are configured to alternatively activate 5000 sub-pixels of the plurality of sub-pixels to provide electrical redundancy.

39. The LCD of any of examples 13-38, further comprising control electronics configured to switch between activating a sub-pixel of the plurality of sub-pixels with said at least one TFT of the first array or at least one TFT of the second array.

40. The LCD of example 39, wherein said control electronics are responsive to a user input to switch between said at least one TFT of the first array and said at least one TFT of the second array.

41. The LCD of example 39, wherein said control electronics are responsive to input from sensor electronics configured to detect a failure in the LCD.

42. The LCD of any of examples 13-41, further comprising one or more near infrared (NIR) absorbers.

43. A method of fabricating a liquid crystal display (LCD) with electrical redundancy, the method comprising:
providing a first thin film transistor (TFT) substrate electrically connected to a first set of integrated circuits (ICs);
providing a second TFT substrate electrically connected to a second set of ICs;
disposing the second TFT substrate above the first TFT substrate;
attaching the second TFT substrate to the first TFT substrate; and
providing liquid crystal (LC) therebetween.

44. The method of example 43, wherein the first set of ICs comprises a first set of source and gate driver ICs, and the second set of ICs comprises a second set of source and gate driver ICs.

45. The method of any of examples 43-44, wherein the first set of ICs comprises a first set of row and column drivers, and the second set of ICs comprises a second set of row and column drivers.

46. The method of any of examples 43-45,
wherein the first and second TFT substrates each comprises:
   a first side,
   a second side adjacent the first side,
   a third side adjacent the second side and opposite the first side, and
   a fourth side adjacent the first and third sides and opposite the second side,
wherein the first set of ICs is disposed on the first and second sides of the first TFT substrate, and
wherein the second set of ICs is disposed on the third and fourth sides of the second TFT substrate.

47. The method of any of examples 43-46, wherein the first TFT substrate is provided with scribe lines and/or cut to resize an active area of the first TFT substrate and/or the second TFT substrate is provided with scribe lines and/or cut to resize an active area of the second TFT substrate.

48. The method of example 47, wherein disposing the second TFT substrate above the first TFT substrate comprises aligning the resized active area of the second TFT substrate above the resized active area of the first TFT substrate.

49. The method of any of examples 47-48, wherein attaching comprises attaching the resized active area of the second TFT substrate to the resized active area of the first TFT substrate.

50. The method of any of examples 47-49, wherein providing the LC comprises providing the LC between the resized active areas of the first and second TFT substrates.

51. The method of any of examples 47-50, wherein the first and second TFT substrates are cut after attaching.

52. The method of any of examples 47-50, wherein the first and second TFT substrates are cut before attaching.

53. The method of any of examples 43-52, wherein attaching occurs prior to providing the LC therebetween.

54. The method of any of examples 43-52, wherein attaching occurs after providing LC on at least one of the first or second TFT substrates.

55. The method of any of examples 43-54, further comprising including one or more near infrared (NIR) absorbers.

56. The method of any of examples 43-55, wherein the LCD comprises the LCD of any of examples 1-42.

57. The LCD of any of examples 17-21, wherein the first, second, third, and fourth sides of the first and second TFT substrates includes one of left, lower, right, and upper edges of the first and second TFT substrates.

58. The LCD of example 57, wherein the first, second, third, and fourth sides of the first and second TFT substrates are adjacent the left, lower, right, and upper edges respectively of the first and second TFT substrates.

59. The LCD of any of examples 13-42 or any of examples 57-58, wherein the first TFT substrate is a primary TFT substrate and the second TFT substrate is a secondary TFT substrate.

60. The method of example 46, wherein the first, second, third, and fourth sides of the first and second TFT substrates includes one of left, lower, right, and upper edges of the first and second TFT substrates.

61. The method of example 60, wherein the first, second, third, and fourth sides of the first and second TFT substrates are adjacent the left, lower, right, and upper edges respectively of the first and second TFT substrates.

62. The method of any of examples 43-56 or any of examples 60-61, wherein the first TFT substrate is a primary TFT substrate and the second TFT substrate is a secondary TFT substrate.

### BRIEF DESCRIPTION OF THE DRAWINGS

The foregoing summary, as well as the following detailed description, will be better understood when read in conjunction with the appended drawings. For the purpose of illustration, there are shown in the drawings certain embodiments of the present disclosure. It should be understood, however, that the invention is not limited to the precise arrangements and instrumentalities shown. In the drawings:

FIG. 1 illustrates the schematic cross-section of an example unit sub-pixel. For presentation clarity, the primary and the secondary TFTs are placed in opposite substrates that share the liquid crystal.

FIG. 2 illustrates a view of an example finished AMLCD with dual redundant pixel driving circuits, with the location of the primary and the secondary row and column drivers.

FIG. 3 illustrates an example of the resizing availability for the primary TFT substrate.

FIG. 4 illustrates an example of the resizing availability for the secondary TFT substrate.

FIG. 5 illustrates an example assembly of the AMLCD with resizing seal lines prior to scribing.

FIG. 6 illustrates a view of an example finished AMLCD with dual redundant pixel drivers, with an alternate sized active area.

FIG. 7 illustrates an example method of fabricating an LCD with electrical redundancy.

### DETAILED DESCRIPTION

The present disclosure will now be described more fully with reference to the Figures in which various embodiments of the present disclosure are shown. The subject matter of the disclosure may, however, be embodied in many different forms and should not be construed as limited to the example embodiments set forth herein.

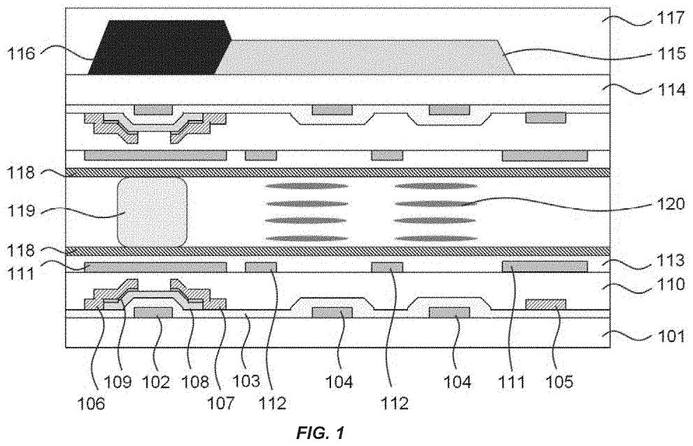

The present disclosure is directed to an AMLCD comprising sub-pixels (e.g., red, green, and blue) forming a single pixel. As with many AMLCDs, the individual pixels can be electrically controlled by row and column drivers (e.g., source and gate ICs). The AMLCD can contain two sets of independent row and column drivers that are connected to the primary and the secondary TFTs, and are controlled by different and redundant sets of drivers. The display can therefore be controlled by either the primary or secondary set of independent row and column drivers by toggling between the two sets of display interface board (DIB) drivers, which drive the ICs that drive the TFTs. FIG. 1. shows an example unit sub-pixel construction of, e.g., an AMLCD display that is electrically redundant. In some designs, the display can include a plurality of pixels comprising sub-pixels. The plurality of pixels can comprise at least 1000 TFTs, 2000 TFTs, 3000 TFTs, 4000 TFTs, 5000 TFTs, etc. (or any range of TFTs formed by such values or the number of pixels can be outside such ranges). In some implementations, a TFT fabrication process includes providing the primary TFT substrate (e.g., glass) 101, which contains the gate electrode 102, gate oxide 103, common electrode 104, data electrode 105, source/drain electrode 106/107, active layer 108, ohmic contact layer 109, interlayer insulation 110, transparent conductor (e.g., ITO) pattern 111, pixel electrode 112 and interlayer insulation/planarization layer 113.

The color filter 115 can be deposited on the front or top side of the secondary TFT substrate 114 (e.g., glass), and the black matrix 116 can be patterned to segment sub-pixels. A planarization layer 117 can be coated on the color filter layer to provide a flat surface.

A similar TFT structure to the primary TFT can also be fabricated onto the secondary TFT substrate 114. The primary and secondary TFTs can be aligned on axis (e.g., vertically aligned on or above one another) in order for the pixels to achieve a high (e.g., maximum) aperture ratio.

Accordingly, in various implementations a first set of TFTs or “primary” TFTs are included on the first or primary substrate (and not on the second or secondary substrate) and a second set of TFTs or “secondary” TFTs are included on the second or secondary substrate (and not on the first or primary substrate.)

A column spacer 119 can be positioned in between the primary and the secondary TFT substrates to maintain a cell gap, and the liquid crystal fluid (e.g., nematic liquid crystal) 120 can be placed in between and shared among the two sets of the TFT substrates.

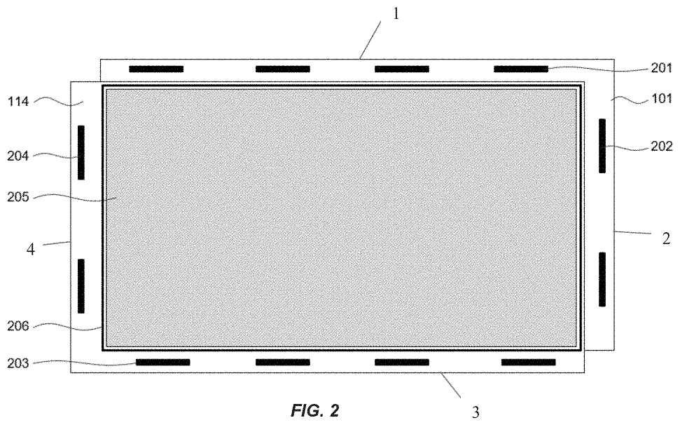

FIG. 2 shows a view of the finished assembly of an example redundant AMLCD display with redundant primary and secondary row and column drivers. Redundant sets of source and gate driver ICs can be attached to the primary TFT substrate 101 and secondary TFT substrate 114. For example, in FIG. 2, the primary column drivers 201 and row drivers 202 are bonded and electrically connected to the primary TFT substrate 101 (not the secondary substrate), and the secondary column driver 203 and row drivers 204 are bonded and electrically connected to the secondary TFT substrate 114 (not the primary substrate). A user or pilot can switch between the primary and secondary display function when a failure is detected. In some implementations, the secondary TFT substrate 114 can be configured to act as an electrical ground plane for the primary TFT substrate 101, and the primary TFT substrate 101 can be configured to act as a ground plane for the secondary TFT substrate 114. In some implementations, the display can include control electronics configured to switch between activating a sub-pixel of the plurality of sub-pixels with at least one TFT of the primary TFTs (the first plurality or array of TFTs on the first substrate) or at least one TFT of the secondary TFTs (the second plurality or array of TFTs on the second substrate). In some instances, for example, the display can include a redundant control system with a first power supply in electrical communication with a first display interface board (DIB) and a second power supply in electrical communication with a second DIB. The redundant control system can also include a graphics processor in electrical communication with the first and second DIBs. The redundant control system can include a reversionary control in electrical communication with the graphics processor and can be configured to allow a user to switch between the first and second DIBs. In some designs, the display can include control electronics configured to detect failure in the display and switch between activating a sub-pixel of the plurality of sub-pixels with at least one TFT of primary TFTs (the first plurality or array of TFTs on the first substrate) or at least one TFT of the secondary TFTs (the second plurality or array of TFTs on the second substrate) based on that detected failure. In some instances, for example, the graphics processor can be adapted to detect a failure in a first and/or second source driver, a first and/or second gate driver, or a first and/or second DIB. In some instances, the first DIB can be adapted to detect a failure in the first source driver or the first gate driver. In some instances, the second DIB can be adapted to detect a failure in the second source driver or the second gate driver. Other configurations are possible.

The active area 205 can be formed by the assembly of the primary TFT substrate 101 and the secondary TFT substrate 114 by an assembly process with preferably, a precise alignment. The seal lines 206 can be applied around the active area 205 prior to an additional assembly process.

In certain implementations, a liquid crystal display (LCD) with electrical redundancy is provided. The display can include a plurality of pixels. Individual pixels can comprise a plurality of sub-pixels (e.g., as shown in FIG. 1). The display can also include a first TFT substrate (e.g., primary TFT substrate 101) and a second TFT substrate (e.g., secondary TFT substrate 114). The first TFT substrate can comprise a first substrate supporting a first array of TFTs, and the second TFT substrate can comprise second substrate supporting a second array of TFTs. In some designs, the first array and the second array of TFTs can each include at least 1000 TFTs, 2000 TFTs, 3000 TFTs, 4000 TFTs, 5000 TFTs, etc. (or any range of TFTs formed by such values or may be outside any such range). The array of TFTs can include two-dimensional (2D) arrays. In some examples, the array of TFTs can include a plurality of row and column electrodes.

As shown in FIGS. 1 and 2, the second TFT substrate 114 can be disposed above the first TFT substrate 101. In some instances, the row and column electrodes of the first TFT substrate 101 and the row and column electrodes of the second TFT substrate 114 can be substantially aligned, substantially overlapping, and/or substantially without offset with respect to each other or any combination thereof. In some instances, the row and column electrodes of the first TFT substrate 101 and the row and column electrodes of the second TFT substrate 114 can be aligned and overlapping such that the average offset with respect to each other is less than 10%. In some instances, the row and column electrodes of the first TFT substrate 101 and the row and column electrodes of the second TFT substrate 114 can be aligned and overlapping such that the average offset with respect to each other is less than 20%. Values outside these ranges, however, are possible, in certain designs.

In various implementations, liquid crystal (LC) (e.g., LC fluid 120) can be disposed between the first 101 and second 114 TFT substrates. In various instances, at least one TFT of the first array of TFTs (e.g., on the first TFT substrate 101) and at least one TFT of the second array of TFTs (e.g., on the second TFT substrate 114) can be configured to alternatively activate a sub-pixel of the plurality of sub-pixels to provide electrical redundancy. In some designs, a majority of TFTs of the first array of TFTs and a majority of TFTs of the second array of TFTs can be configured to alternatively activate a majority of the sub-pixels of the plurality of sub-pixels to provide electrical redundancy. In some designs, the TFTs of the first array of TFTs and the TFTs of the second array of TFTs can each be configured to activate all of the sub-pixels to provide electrical redundancy. As discussed above, the first set or array of TFTs and the second set or array of TFTs are on the first TFT substrate and the second TFT substrate, respectively, and thus can provide independent redundant control of the pixels and subpixels if one of the first set or array of TFTs or second set or array of TFTs is for some reason preferred (e.g., the other set or array is at least partially disabled, limited, or for some other reason is less desired).

In some examples, at least 1000 TFTs of the first array of TFTs and 1000 TFTs of the second array of TFTs can be configured to alternatively activate at least 1000 sub-pixels of the plurality of sub-pixels to provide electrical redundancy. In some examples, at least 3000 TFTs of the first array of TFTs and 3000 TFTs of the second array of TFTs can be configured to alternatively activate at least 3000 sub-pixels of the plurality of sub-pixels to provide electrical redundancy. In some examples, at least 5000 TFTs of the first array of TFTs and 5000 TFTs of the second array of TFTs can be configured to alternatively activate at least 5000 sub-pixels of the plurality of sub-pixels to provide electrical redundancy. Any number of TFTs and sub-pixels in any range between these values are possible as well as numbers outside these ranges.

In some implementations, the display can include a control or control electronics configured to switch between activating a sub-pixel of the plurality of sub-pixels with at least one TFT of the first array of TFTs (e.g., on the first TFT substrate 101) or at least one TFT of the second array of TFTs (e.g., on the second TFT substrate 114). In some instances, the control or control electronics can be responsive to a user input to switch between the at least one TFT of the first array of TFTs and the at least one TFT of the second array of TFTs. In some instances, the control or control electronics can be responsive to input from sensor electronics configured to detect a failure in the LCD.

In some implementations, a first set of ICs can be electrically connected to the first TFT substrate and configured to drive TFTs in the first array of TFTs (and not the TFTs in the second array of TFTs). Similarly, a second set of ICs can be electrically connected to the second TFT substrate and configured to drive TFTs in the second array of TFTs (and not the TFTs in the first array of TFTs). The first set of ICs can include, for example, a first set of source and gate driver ICs, and the second set of ICs can include, for example, a second set of source and gate driver ICs. As shown in FIG. 2, the first set ICs can comprise a first set of row 202 and column 201 drivers, and the second set of ICs can comprises a second set of row 204 and column 203 drivers. In various implementations, the first set of ICs, first set of source and gate drivers, and/or first set of row 202 and column 201 drivers can be configured to control the first set or array of TFTs on the first TFT substrate or primary substrate and not the second set or array of TFTs on the second TFT substrate or secondary substrate. Similarly, the second set of ICs, second set of source and gate drivers, and/or second set of row 202 and column 201 drivers can be configured to control the second set or array of TFTs on the second TFT substrate or secondary substrate and not the first set or array of TFTs on the first TFT substrate or primary substrate. Additionally, in some designs, the first set of ICs, first set of source and gate drivers, and/or the first set of row 202 and column 201 drivers may be on the first TFT substrate and not on the second TFT substrate. Similarly, in some designs, the second set of ICs, second set of source and gate drivers, and/or second set of row 202 and column 201 drivers may be on the second TFT substrate or secondary substrate and not on the first TFT substrate or primary substrate.

With continued reference to FIG. 2, the first 101 and second 114 TFT substrates each can comprise a first side 1, a second side 2 adjacent the first side 1, a third side 3 adjacent the second side 2 and opposite the first side 1, and a fourth side 4 adjacent the first 1 and third 3 sides and opposite the second side 2. As an example, the first 1, second 2, third 3, and fourth 4 sides can include one of upper, right, lower, and left edges of the first 101 and second 114 TFT substrates. In one example configuration shown, the first set of ICs (e.g., column 201 and row 202 drivers) can be disposed on the first 1 and second 2 sides of the first TFT substrate 101 and not the third 3 and fourth 4 sides of the first TFT substrate 101. In such example, the second set of ICs (e.g., column 203 and row 204 drivers) can be disposed on the third 3 and fourth 4 sides of the second TFT substrate 114 and not the first 1 and second 2 sides of the second TFT substrate 114.

In various implementations, no TFT on the first TFT substrate 101 is electrically connected to and/or driven by an IC on the third 3 and fourth 4 sides of the first TFT substrate 101. In various implementations, no TFT on the second TFT substrate 114 is electrically connected to and/or driven by an IC on the first 1 and second 2 sides of the second TFT substrate 114. In some instances, the display can comprise a control or control electronics configured to switch between the first 201, 202 and second 203, 204 sets of ICs. By being able to switch between the first 201, 202 and second 203, 204 sets of ICs, the display can switch between the first 101 and second 114 TFT substrates, providing electrical redundancy.

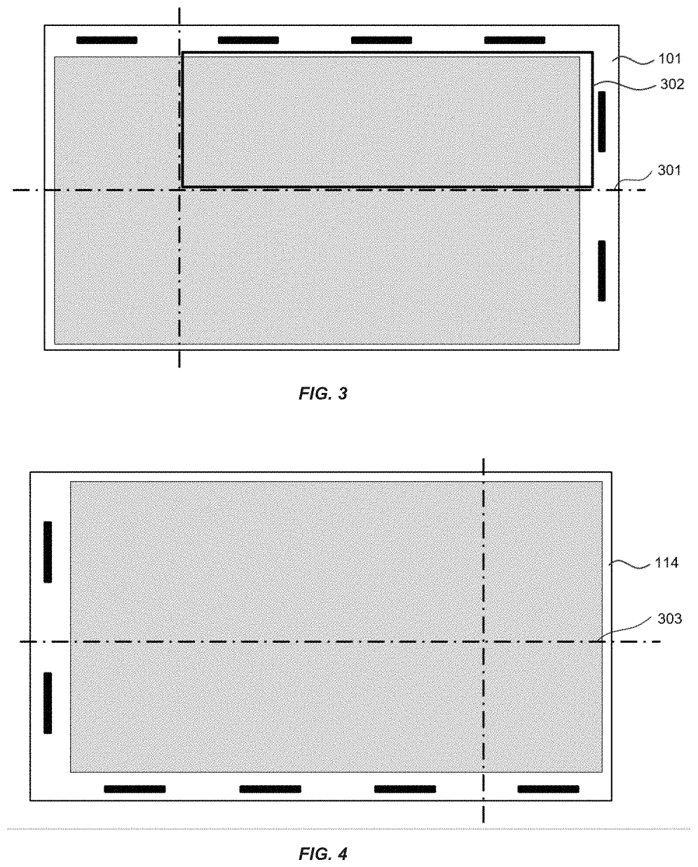

In various implementations, the display can be resized. FIG. 3 shows an example of the resize availability by cutting the primary TFT substrate 101. The primary TFT substrate scribe lines 301 indicates the new resized aspect ratio. The seal lines 302 can be applied around the resized active area on the primary TFT substrate 101.

FIG. 4 shows an example of the resizing available by cutting the secondary TFT substrate 114. The secondary TFT substrate scribe lines 303 indicates the resizing aspect ratio.

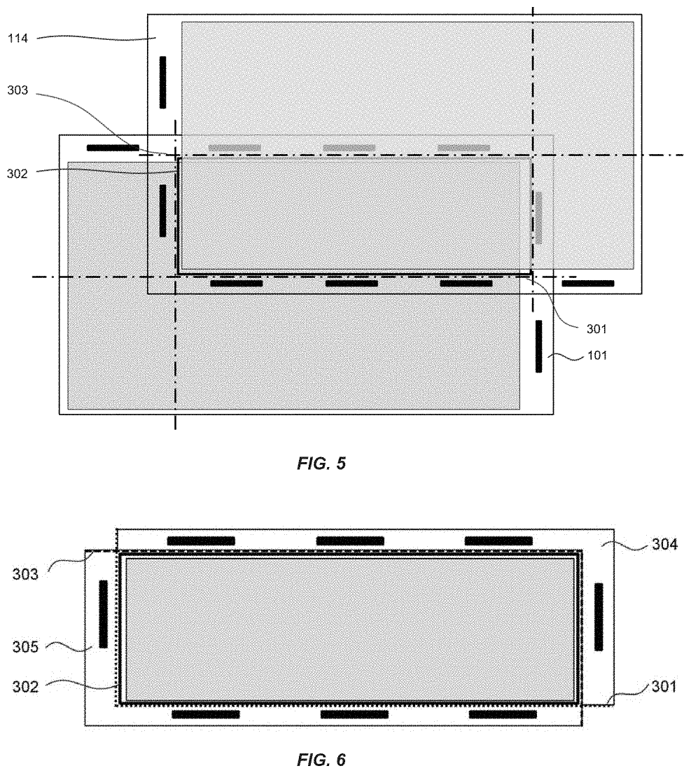

FIG. 5 shows an example assembly of the resized AMLCD before the substrates are cut by the primary scribe lines 301 and the secondary scribe lines 303.

FIG. 6 shows the finished view of an example resized AMLCD with the revised aspect ratio. The size and the aspect ratio of the resized primary TFT substrate 304 and the secondary TFT substrate 305 can be determined by the scribe lines 301 and 303. With the ICs on two sides (e.g., on only two sides) per TFT substrate, the AMLCD can be finished using standard processes including perimeter seal, one drop fill of liquid crystal nematic fluid, assembly glass, and chip on glass bonding. In some instances, the active area of the resized display can be determined by a location of a seal placed on an active TFT pixel element prior to adding the nematic fluid. In some instances, the final size of the AMLCD active area can be defined by the position of the perimeter seal and the subsequent substrate cutting process. In some instances, sealing can keep the liquid crystal nematic fluid in the active area between the primary TFT substrate 304 and the secondary TFT substrate 305.

The AMLCD may include near infrared filtering technology such as described in U.S. Pat. No. 9,927,562, entitled “NVIS COLOR FILTER AND A LIQUID CRYSTAL DISPLAY DEVICE INCLUDING THE SAME”, filed on May 28, 2015, which is incorporated herein by reference. In some instances, the color picture element can contain near infrared absorbers. The color picture element can be formed on a transparent substrate, for example, by any of the suitable manufacturing techniques known in the art, such as pigment dispersion, dyeing, printing and electrodeposition. To directly incorporate near infrared (NIR) absorber into a color picture element, a dye can be dissolved in a processing solvent and then combined with a color pigment and a binder resin. In one embodiment, a NIR pigment can be mixed with a color forming pigment and this mixture can be dispersed in a binder resin. The NIR filtering material can be organic or inorganic dye or a pigment, which absorb light in the red and infrared regions of the electromagnetic spectrum. Preferably, the NIR absorbers have an absorption peak between 650 nm and 950 nm and a limited absorption between 400 nm and 620 nm of the electromagnetic spectrum. Preferably, for the practice of some implementations, NIR absorbers can have excellent thermal and photo-stability.

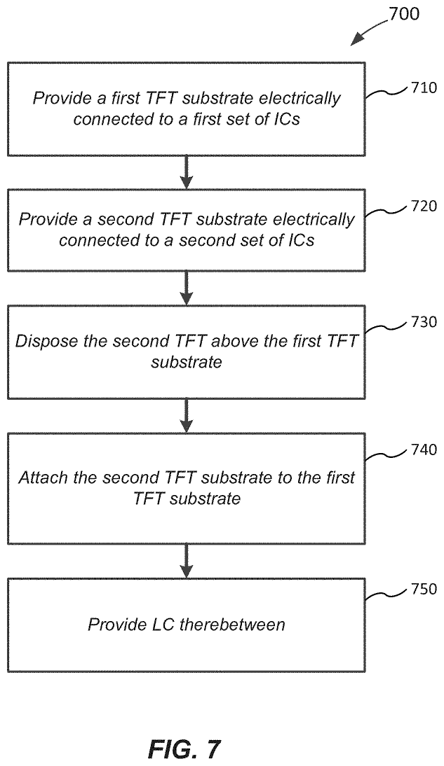

FIG. 7 illustrates an example method of fabricating an LCD with electrical redundancy. The method 700 can include providing a first TFT substrate electrically connected to a first set of ICs, as shown in block 710, and providing a second TFT substrate electrically connected to a second set of ICs, as shown in block 720. The method 700 can also include disposing the second TFT substrate above the first TFT substrate, as shown in block 730. The method 700 can further include attaching the second TFT substrate to the first TFT substrate, as shown in block 740, and providing LC therebetween, as shown in block 750. With respect to blocks 710 and 720, the first set of ICs can comprise a first set of source and gate driver ICs, and the second set of ICs can comprise a second set of source and gate driver ICs. As an example, the first set of ICs can include a first set of row and column drivers, and the second set of ICs can include a second set of row and column drivers.

In some implementations, the first and second TFT substrates each can have a first side, a second side, a third side, and a fourth side. The second side can be adjacent the first side. The third side can be adjacent the second side and opposite the first side. The fourth side can be adjacent the first and third sides and opposite the second side. In some implementations, a first set of source and gate driver ICs can be disposed on the first and second sides of the first TFT substrate (e.g., as shown in FIG. 3). In some implementations, the second set of source and gate driver ICs can be disposed on the third and fourth sides of the second TFT substrate (e.g., as shown in FIG. 4). The first TFT substrate can be provided with scribe lines (e.g., as shown in FIG. 3) and/or cut to resize an active area of the first TFT substrate and/or the second TFT substrate can be provided with scribe lines and/or cut to resize an active area of the second TFT substrate (as shown in FIG. 4).

With respect to block 730, disposing the second TFT substrate above the first TFT substrate can comprise aligning the resized active area of the second TFT substrate above the resized active area of the first TFT substrate (as shown in FIG. 5). With respect to block 740, attaching the second TFT substrate to the first TFT substrate can comprise attaching the resized active area of the second TFT substrate to the resized active area of the first TFT substrate. With respect to block 750, providing the LC can comprise providing the LC between the resized active areas of the first and second TFT substrates. In some methods, the first and second TFT substrates can be cut after attaching the second TFT substrate to the first TFT substrate. In some methods, the first and second TFT substrates can be cut before attaching the second TFT substrate to the first TFT substrate. In some methods, attaching the second TFT substrate to the first TFT substrate can occur prior to providing the LC therebetween. In some methods, attaching the second TFT substrate to the first TFT substrate can occur after providing LC on at least one of the first or second TFT substrates. In some instances, the method 700 can further comprise including one or more NIR absorbers.

The example fabrication methods are not limited to any particular order and may be performed in some other manner, e.g., a different order or some steps performed in parallel. As an example, the steps may be rearranged or reordered. In some instances, the ICs can be placed on the substrate prior to assembly. In some instances, the ICs can be placed on the substrate after assembly. In addition, one or more additional steps may be performed before, after, simultaneously, or between any of the illustrated blocks.

It will be appreciated by those skilled in the art that changes could be made to the examples described above without departing from the broad inventive concept thereof. It is understood, therefore, that the invention disclosed herein is not limited to the particular embodiments disclosed, but it is intended to cover modifications within the spirit and scope of the present invention as defined by the appended claims.

1.-8. (canceled)

9. An active matrix liquid crystal display that is electrically redundant and can be resized comprising:
primary and secondary thin film transistor (TFT) substrates sharing the same nematic fluid, the primary and secondary TFT substrates vertically aligned on or above one another; and
redundant sets of source and gate driver ICs that are attached to the primary and secondary TFT substrates,
wherein an active area of the resized liquid crystal display is determined by a location of a seal placed on an active TFT pixel element.

10.-12. (canceled)

13. A liquid crystal display (LCD) with electrical redundancy, the LCD comprising:
a plurality of pixels, individual pixels comprising a plurality of sub-pixels;
a first thin film transistor (TFT) substrate comprising a first substrate supporting a first array of TFTs;
a second TFT substrate comprising a second substrate supporting a second array of TFTs, the second TFT substrate disposed above the first TFT substrate;
liquid crystal (LC) disposed between the first and second TFT substrates.

14. The LCD of claim 13, further comprising:
a first set of integrated circuits (ICs) electrically connected to the first TFT substrate and configured to drive TFTs in the first array of TFTs; and
a second set of ICs electrically connected to the second TFT substrate and configured to drive TFTs in the second array of TFTs.

15. The LCD of claim 14, wherein the first set of ICs comprises a first set of source and gate driver ICs, and the second set of ICs comprises a second set of source and gate driver ICs.

16. (canceled)

17. The LCD of claim 14,
wherein the first and second TFT substrates each comprises:
a first side,
a second side adjacent the first side,
a third side adjacent the second side and opposite the first side, and
a fourth side adjacent the first and third sides and opposite the second side,
wherein the first set of ICs is disposed on the first and second sides of the first TFT substrate and not said third and fourth sides of the first TFT substrate, and
wherein the second set of ICs is disposed on the third and fourth sides of the second TFT substrate and not said first and second sides of the second TFT substrate.

18. The LCD of claim 17, wherein no TFT on said first substrate is electrically connected to an IC on said third and fourth sides of the first TFT substrate.

19. The LCD of claim 17, wherein no TFT on said second substrate is electrically connected to an IC on said first and second sides of the second TFT substrate.

20. The LCD of claim 17, wherein no TFT on said first substrate is configured to be driven by an IC on said third and fourth sides of the first TFT substrate.

21. The LCD of claim 17, wherein no TFT on said second substrate is configured to be driven by an IC on said first and second sides of the second TFT substrate.

22. The LCD of claim 14, further comprising a control configured to switch between the first and second sets of ICs.

23. The LCD of claim 13, wherein the first and second TFT substrates each comprises a plurality of row and column electrodes.

24. The LCD of claim 23, wherein the row and column electrodes of the first TFT substrate and the row and column electrodes of the second TFT substrate are substantially aligned, substantially overlapping, and substantially without offset with respect to each other.

25. The LCD of claim 23, wherein the row and column electrodes of the first TFT substrate and the row and column electrodes of the second TFT substrate are aligned and overlapping such that the average offset with respect to each other is less than 10%.

26. The LCD of claim 23, wherein the row and column electrodes of the first TFT substrate and the row and column electrodes of the second TFT substrate are aligned and overlapping such that the average offset with respect to each other is less than 20%.

27. The LCD of claim 13, wherein the first and second arrays of TFTs each comprise two-dimensional (2D) arrays.

28. The LCD of claim 13, wherein the majority of TFTs of the first array and the majority of TFTs of the second array are configured to alternatively activate a majority of the sub-pixels of the plurality of sub-pixels to provide electrical redundancy.

29.-38. (canceled)

39. The LCD of claim 13, further comprising control electronics configured to switch between activating a sub-pixel of the plurality of sub-pixels with said at least one TFT of the first array or at least one TFT of the second array.

40. The LCD of claim 39, wherein said control electronics are responsive to a user input to switch between said at least one TFT of the first array and said at least one TFT of the second array.

41. The LCD of claim 39, wherein said control electronics are responsive to input from sensor electronics configured to detect a failure in the LCD.

42. The LCD of claim 13, further comprising one or more near infrared (NIR) absorbers.

43.-62. (canceled)
